(19) United States
(12) Patent Application Publication
(10) Pub. No.: US 2006/0004626 A1
(43) Pub. Date: Jan. 5, 2006

(54) Targeted marketing for subscriptions

(76) Inventors: Eric Holmen, Aliso Viejo, CA (US); Mark Hertenstein, Westport, CT (US); David Diamond, New York, NY (US)

Correspondence Address: NEIFELD IP LAW, PC, 4813-B EISENHOWER AVENUE, ALEXANDRIA, VA, 22304, US

(21) Appl. No.: 10/530,878

(22) PCT Filed: Oct. 31, 2002
(86) PCT No.: PCT/US02/31609

§ 371 Date: Apr. 11, 2005

(51) Int. Cl. G06F 17/00

(52) U.S. Cl. 705/14

(57) ABSTRACT

A system and method for utilizing point of sale data to target individuals with invitations for magazine subscriptions. A consumer receives an invitation for a magazine subscription and can purchase a magazine subscription in a retail store. When the consumer purchases a subscription at a retail store, they receive a cash incentive redeemable at the store. Consumers are made offers depending on selecting criteria including purchasing a magazine or being in the top percentage of spenders.

### FIELD OF THE INVENTION

The present invention relates to marketing. More particularly, the invention relates to marketing using Point of Sale (POS) systems.

Magazine publishers have used common direct marketing data modeling to identify prospective subscribers based on demographics, psycho graphics, and lifestyle data. Subscription purchases were paid for with a credit card, check or redemption of loyalty points. The current state of the art relies on either “bill me later” or credit card payment for magazine subscriptions.

Terms used in this application are defined below.

Database, in this application, means data organized in some format in a computer memory that can be accessed by an associated computer system. Such a concept is also referred to as a database management system. A database or database management system includes commercial database products such as the Microsoft Access and SQL Server, as well as any set of files stored in computer memory that can be accessed by an associated computer system.

Value means a good, a service, or a pecuniary interest including cash, check, credit, and conditional credit.

Transaction, in this application, means an exchange involving at least two legal entities. A purchase is a transaction. Receipt of an incentive offer, redemption of an incentive offer, and acceptance of participation in a consumer survey are transactions.

Purchase, in this application, means a transaction involving at least two parties in which cash, check, charge or credit is exchanged for one or more goods and services.

Incentive offer, in this application, means value offered to a consumer the receipt of which by the consumer is contingent upon the consumer entering into a specified transaction. An incentive offer is sometimes referred to as incentive.

Cash incentive, in this application, is a type of incentive offer that involves giving the consumer cash in response to the consumer entering into the specified transaction.

CID, in this application, means a consumer identification code linked to a consumer. A CID can be a credit card number, a driver's license number, a social security number, a frequent shopper card code, or an identification code uniquely associated with the consumer or the consumer's household.

POS, in this application, means point of sale, which is the area where a consumer engages in transactions.

POS terminal, in this application, means a terminal where transaction data is entered. A POS terminal may also be referred to as a checkout.

Retail store POS terminal, in this application, means a POS terminal physically located inside of or adjacent a retail store such that customers can walk with items from the retail store that they wish to purchase to the retail store POS terminal.

Product purchase data includes data regarding products purchased, price of products purchased, date of purchase, type of payment, redemption amounts, products that qualified for redemptions, subscription amount, periodical publication for which a subscription is sold, incentive offer data including incentive amounts and conditions, and CID associated with the purchases.

Transaction data means data associated with a specified transaction. Transaction data includes transaction price, transaction date, description of items involved in the transaction, location of the transaction (such as POS terminal, POS lane, identification of store), credit authorization data, and entities involved in the transaction (such as cashier, purchaser, store, credit card company, and purchaser's bank).

POS data, in this application, is the data entered at or transmitted to a POS terminal in connection with a transaction. POS data may include transaction data and product purchase data.

UPC, in this application, means a Universal Product Code, and it is a code that uniquely identifies a type of product.

Periodical publication, in this application, means information that is periodically published and associated with a name, such as a name of a magazine or a name of a news paper. Periodical publications include both information published on paper and information published electronically.

Issue, in this application, as it pertains to a periodical publication, means a document of published information identified by the name of the periodical publication.

Subscription, in this application, means a contract for purchase of issues of a periodical publication, such as for all or certain issued published over a specified duration, for a specified number of issues, or for a specified number of types of issues such as only weekend or monthly issues. A subscription may define the mechanism of delivery, such as deliver of paper to a residence address, email to an email address, or posting on a web site for retrieval by a web browser.

Subscription offer, in this application, means an offer for purchase of a subscription to a periodical publication, such as a printed or electronically distributed magazine or newspaper.

Subscription duration, in this application, means the duration over which a periodical publication will be distributed to the person purchasing the subscription.

Invitation, in this application, means a solicitation that is associated with a transaction and that includes an offer to purchase, such as an offer to purchase a subscription to a periodical publication, a product, or a service. The invitation may include the terms of the offered subscription and one or more incentive offers associated with the offer to purchase the subscription.

Invitation code, in this application, is data defining a code that is associated with an invitation. An invitation code may be embodied as an unique bar code. Preferably, the code is unique, in the sense that it is associated in a database with data that uniquely identifies the invitation.

Invitation offer criteria, in this application, means criteria that determines whether an invitation will be offered to a consumer.

Transaction tracking code, in this application, means a unique code associated with a transaction. The transaction tracking code is also associated with a periodical publication's name, such as a magazine's name, the duration of a subscription, and the price for the subscription. This is also referred to as unique tracking code. The association typically exists in computer memory in a database.

Confirmation, in this application, means an acceptance by a consumer of an invitation, as indicated by the customer's purchasing the subscription offered in the invitation.

### SUMMARY OF THE INVENTION

### OBJECTS OF THE INVENTION

An object of the invention is to effectively promote sales of periodical publications.

Another object of this invention is to provide a system that enables individuals to purchase subscriptions to periodical publications using POS systems technology.

Another object of the invention is to promote sales of periodical publications using POS system technology.

It is another object of the invention is to enable both offers for sale of items that are not items stocked in a retail store (non stock items) and receipt of payment for non stock items at the retail store's POS terminal.

Another object of this invention is to effectively deliver invitations to consumers by applying criteria to POS data associated with the consumers to determine to which consumers to deliver an invitation.

Another object of this invention is to effectively deliver invitations to consumers by applying criteria to POS data associated with the consumers to determine which of a plurality of invitations to deliver to any particular consumer.

Another object of this invention is to provide a system that can deliver to a consumer an invitation that include a code, typically embodied in bar code format, wherein the code is associated in a database with the terms of the subscription offer defined by the invitation.

Another object of this invention is to provide a system that can deliver a confirmation message that includes a unique tracking code, confirmation of order (magazine name, term, price) and value.

Another object of this invention is to enables retailers to earn commissions on subscriptions purchased using their POS systems.

Another object of this invention is to provide invitations that include an incentive offer the terms of which include the consumer purchasing the corresponding periodical subscription in specified retail store or chain of retail stores.

These and other objects of the invention are provided by a novel computer network system including a retail store computer system having a POS terminal, a database containing at least POS data associated with a consumer's POS transactions, computer means for determining whether a consumer meets invitation criteria, and means to deliver an invitation to the consumer, means to receive from the consumer acceptance of the invitation, and means to activate a subscription for the consumer.

The novel computer network system enables invitations to be offered to a consumer at a POS terminal while the consumer is at the POS terminal, at the consumer's residence address via mail, at an email address associated with the consumer, or via a web site to which the consumer can point a Web browser program residing on a the consumer's computer.

The novel computer network system enables invitations to be targeted to consumers meeting invitation offer criteria, such as data indicating purchase by the consumer of an issue of a periodical publication, purchase of an issue of a periodical publication competing with the periodical publication for which an invitation may be offered, purchase of any issue of any periodical publication, purchase of publication, demographic data, which may indicate a preference for information of a type associated with the periodical publication for which an invitation may be offered, analysis of POS data associated with the consumer categorizing the consumer in a category relatively likely to accept an invitation, analysis of POS associated with the consumer indicating a demographic associated with the content of the periodical publication for which an invitation may be offered, or analysis of POS data ranking consumers in a population (such as a ranking identifying consumers by amount spent).

The novel computer network system enables an invitation provided to a consumer to be accepted by the consumer at a POS terminal, and it enables the POS system to identify the specified invitation and consumer accepting the invitation by having a bar code associated with the invitation scanned at the POS terminal. Alternatively, the consumer may accept the invitation by mailing the invitation and check or credit authorization to a specified location where a bar code associated with the invitation may be scanned to read into computer memory the invitation, the consumer, and preferably the check or credit authorization. Alternatively, the consumer may accept the invitation by providing specified data over the Internet to a web site associated with the invitation, and preferably returning a retail store associated with the invitation to obtain the value and comply with any additional terms associated with any incentive offers included in the invitation.

The novel computer network system enables the charge to the consumer for accepting an invitation to be included in a transaction by the consumer at a POS terminal for other goods and services.

The novel computer network system enables the data associated with the payment at a POS terminal of a retail store by the consumer for accepting the invitation to stored in a database, and thereby enables that payment to be efficiently divided between the retailer and the company producing the periodical publication.

Since the consumer can buy the magazine at checkout, this allows the retailer to earn a percent of the subscription without having to inventory merchandise. The subscriptions are non-SKU (stock keeping unit), non-inventoried items.

In one aspect, the invention provides a computer network implemented system and method, comprising the step of: receiving a CID; storing said CID in memory in association with an invitation code when data associated with said CID meets invitation offer criteria associated with said invitation code; storing in association with said invitation code contract terms comprising terms for a contract for a subscription to a periodical publication; transmitting to an offer terminal data defining said CID and said invitation code in order to provide an invitation to a consumer; receiving from an acceptance terminal said invitation code in association with said CID subsequent to said transmitting indicating acceptance of said invitation by said consumer; and storing said CID in association with a transaction tracking code.

The foregoing offer terminal preferably comprises an in store POS terminal, but could also be a printer at a facility for mailing invitations to an address associated with a CID or a computer in a consumer's home.

Additional aspects include means for determining whether consumer data associated with said CID meets said invitation offer criteria; wherein said invitation offer criteria comprises criteria for POS data; wherein said invitation offer criteria comprises criteria for block data; wherein said invitation offer criteria comprises criteria for preference data; wherein said invitation offer criteria comprises criteria for profile data; wherein said invitation offer criteria comprises criteria for demographic data; wherein said invitation offer criteria comprises criteria for magazine purchases; wherein said contract terms comprise a name of said periodical publication; wherein said contract terms comprise a price for said subscription; wherein said contract terms comprise an expiration date for said invitation; wherein said contract terms include terms of an incentive offer; wherein said terms of said incentive offer include acceptance of said invitation; wherein said terms of said incentive offer include a cash discount; wherein said transmitting comprises transmitting when said CID is involved in a transaction at said offer terminal; further comprising, updating an invitation offer record in an invitation offer database to indicate code associated with said record has been used in an invitation offered to a customer; wherein said invitation offer record also stores at least one of the following items: a name of a periodical publication, a subscription price, an offer expiration date, and an incentive offer; wherein said invitation offer record also stores at least two of the following items: a name of a periodical publication, a subscription price, an offer expiration date, and an incentive offer; further comprising generating or updating a consumer invitation record in a consumer invitation database to store a CID and a unique code; wherein said consumer invitation record also stores at least one or two of the following items: a name of a periodical publication, a subscription price, an invitation expiration date, incentive offer, subscription term; wherein said consumer invitation record also stores data indicating whether said invitation has been provided to said consumer; further comprises receiving payment for said subscription when receiving from said acceptance terminal said invitation cod; further comprising receiving payment for product purchases concurrently with receiving said payment for said subscription; further comprising generating a consumer confirmation record in a consumer confirmation database after receiving from said acceptance terminal said invitation code; wherein said consumer confirmation record includes a CID and a transaction tracking code; wherein said consumer confirmation record also includes at least one of the following items: a name of a periodical publication, a subscription price, a subscription term, a confirmation activation expiration date, an incentive offer, and an incentive offer expiration date; wherein said consumer confirmation record also includes at least two of the following items: a name of a periodical publication, a subscription price, a subscription term, a confirmation activation expiration date, an incentive offer, and an incentive offer expiration date; wherein at least one criteria of said invitation offer criteria is whether a magazine is purchased; wherein at least one criteria of said invitation offer criteria is whether said consumer user is in a specified top fraction of spenders; wherein said invitation is provided to said consumer via direct mail; wherein said invitation is provided to said consumer via printing at an in-store printer; further comprising activating said subscription; wherein said activating comprises receiving at an activation center a telephone call from said consumer; wherein said activating comprises receiving a mailing from said consumer; wherein said activating comprises receiving activation data transmitted by said consumer over the Internet; further comprising printing said invitation and including a printed unique bar code; wherein magazine name, magazine subscription price, and offer expiration date are encrypted in said unique bar code; wherein magazine name, magazine subscription price and offer expiration date are encrypted in said transaction tracking cod; further comprising providing at least two of the following items: a retail store computer system, a central computer system; an activation center computer system, a publisher computer system, a mailing facility computer system, and a coupon clearing house computer system; further comprising providing at least three of the following items: a retail store computer system, a central computer system; an activation center computer system, a publisher computer system, a mailing facility computer system, and a coupon clearing house computer system; further comprising storing POS data in association with CIDS in a consumer data database; and wherein said consumer data database also stores in association with CIDs at least one of the following items: profile data, preference data, demographic data, and block data.

In a preferred embodiment, when or after a consumer purchases goods in retail store, the retail store's computer system transfers consumer transaction data and product purchase data to central computer system. Central computer system then generates an invitation based on the consumer purchase product data. Computer system transfers the invitation to the consumer via in-store printer. The invitation contains an expiration date, an incentive for the magazine and/or groceries at the retail store, a unique bar code, a title of a periodical, such as a magazine, the price of the periodical, and instructions on how to use the invitation to purchase a subscription for a periodical. The instructions preferably indicates that the customer will receive a coupon for money off the customer's next shopping order, and indicates that instruction on how to activate the subscription will be printed on a confirmation to be received when the consumer accepts the invitation. The confirmation preferably include a telephone number to call for activation. The invitation may indicate when to expect arrival of issues of the subscription.

When a cashier at a POS terminal enters the code on an invitation into the POS system, the cost of the subscription indicated in the invitation is added to the consumers total charge for current purchases. Next, a confirmation message is printed on an in-store printer. A cash incentive for a future shopping trip at the participating retailer may also be printed on an in-store printer and handed to the consumer.

The printed confirmation includes confirmation of order (magazine name, term, price), a term by which the subscription must be activated, a transaction tracking code, instructions for activation, and an incentive offer for shopping at the retail store. For example, instructions that are printed on the confirmation for activation may include using a touch-tone phone to call a telephone number within a certain time period of receipt of confirmation. Instructions may instruct the consumer to provide consumer's tracking number and their name and address. The confirmation may also state legal text including the expected arrival of issues of the subscription once activated, and the cancellation policy. The confirmation preferably instructs the consumer to retain the cash register receipt and the confirmation as verification of the subscription. The confirmation preferably states that, if 24 consecutive months pass before the paid confirmation is activated, the publisher reserves the right to charge a service fee for the subscription and, if the post office notifies the customer that the magazine is undeliverable, the mailing facility has no further obligation unless they receive a corrected address within two years.

The confirmation may also contain a cash incentive offer for the consumer contingent upon accepting the invention, in which case the cash incentive can be obtained at the retail store. The confirmation may contains an expiration date, a unique bar code, and an indication of the value of the incentive to which the consumer is entitled. For example, everyone who accepts an invitation to a subscription to Time magazine may receive $5.00 off the total charge for their next shopping transaction in the retail store where they obtained the invitation. The incentive is typically paid for by the company that owns the magazine.

The consumer then calls a toll free number to activate the subscription and may also confirm the order information. Consumer will then receive issues of the subscription, delivered by a mailing facility.

### BRIEF DESCRIPTION OF THE DRAWINGS

FIG. 1 is a system overview;

FIG. 2 is an overview of a retail store computer system;

FIG. 3 is a database record for the consumer database product purchase history;

FIG. 4 is a database record of available invitations;

FIG. 5 is a database record of a consumer invitation;

FIG. 5A is a database record of necessary fields of a consumer invitation;

FIG. 5B is a database record of option fields of a consumer invitation;

FIG. 6 is a database record of consumer acceptance;

FIG. 7 is a high level view flowchart showing the steps of the inventive processes;

FIG. 8 is a middle level flowchart showing steps for deciding to provide an invitation corresponding to step 710 of FIG. 7;

FIG. 9 is a middle level flowchart showing steps for receiving payment and activating subscription corresponding to steps 730 and 740 of FIG. 7.

### DETAILED DESCRIPTION OF THE PREFERRED EMBODIMENTS

The same reference numeral refers to the same or corresponding elements throughout the figures.

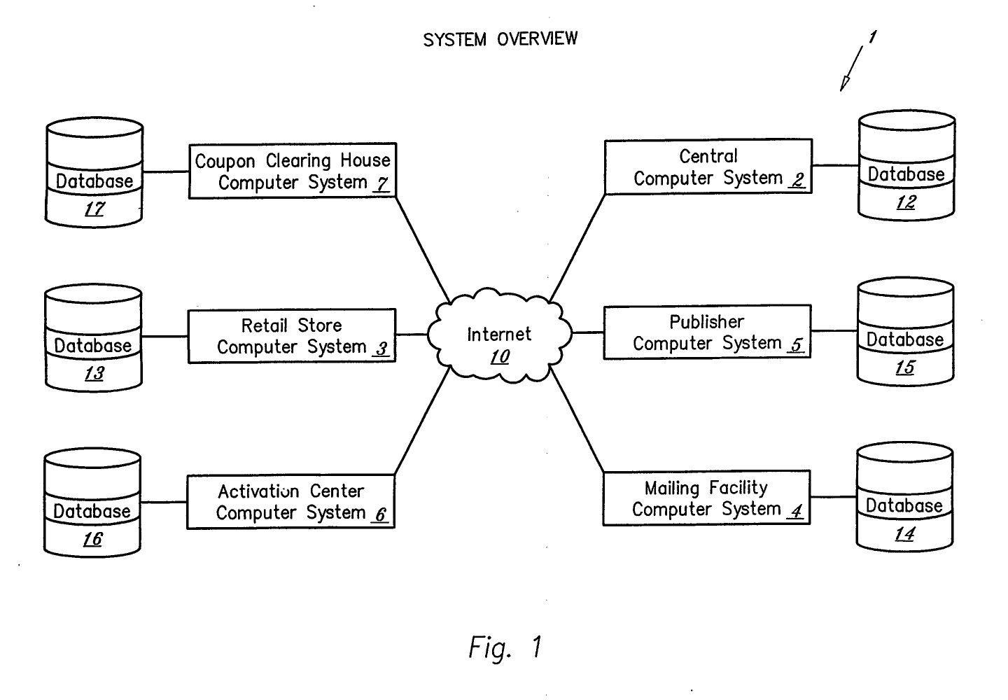

FIG. 1 shows an overview of computer network system 1, including network 10, preferably the Internet, central computer system 2, retail store computer system 3, mailing facility computer system 4, publisher computer system 5, activation center computer system 6, and coupon clearing house computer system 7. FIG. 1 also shows databases 12, 13, 14, 15, 16, and 17, one of which is associated with each one of computer systems 12-17, respectively. The lines connecting elements in FIG. 1 indicate a means for data transmission including include wire and wireless transmission hardware, data format, and transmission protocols.

Each one of computer systems 2-7 includes at least one digital computer including associated central processor, memory, input, and output devices.

There is a legal entity that owns central computer system 2, referred to herein as the marketing company. The marketing company preferably sells marketing services to other entities, including publishers of periodical publications. Central computer system 2 preferably functions to determine wether to offer an invitation to a consumer identified with a data record associated with retail store computer system 3, and, when the determination is to offer the consumer an invitation, transmits an instruction to retail store computer system 3 to offer that consumer that invitation. Central computer system 2 may also function to perform the functions of any of the other computer systems shown in FIG. 1.

There are one or more retail stores associated with retail store computer system 3. Retail store computer system 3 preferably functions to control transactions recorded at POS terminals associated with the foregoing retail stores.

There is a mailing facility associated with mailing facility computer system 4. The mailing facility is a facility that mails items. The mailing facility may mail invitations to postal addresses of consumers. The mailing facility may mail issues of printed periodicals to postal addresses of consumers. The mailing facility may be operated by a fulfillment center, which is an organization that mail postal items for other entities on a contract basis. Mailing facility computer system 4 preferably functions to account for mailings performed by the associated mailing facility.

There is a publisher associated with publisher computer system 5. The publisher is the legal entity that publishes issues of a periodical publication. In the context of this application, the publisher also means the entity that receives remuneration for selling issues of its periodical publication, even though in certain instances publishers contract out the actual publication of their periodicals to printing companies. Publisher computer system 5 preferably functions to account for transactions involving the publisher, which may include data relating to invitation offers and acceptances, subscriptions for the periodical publication, accounts with retailers, and accounts with marketing companies.

There is an activation center associated with activation center computer system 6. The activation center is the location where consumers may telephone to activate the subscriptions they purchase. The activation center will then process their order and forward the information on the fulfillment house 5. Activation center computer system 6 preferably functions to account for subscription that have been activated, preferably stores activation information in database 16, and preferably communicates instructions for fulfilling subscription contracts to the mailing facility 4 or mailing facility computer system 14, and preferably communicates information indicating invitations accepted or subscriptions that have been activated to the publisher or publisher computer system 5.

There is a coupon clearing house associated with coupon clearing house computer system 7. The coupon clearing house is a facility where coupons redeemed are counted and reconciled with the retailers and manufacturer's data indicating the number of coupons redeemed. Coupon clearing house computer system 7 preferably functions to count coupons redeemed and report information regarding reconciliation of coupon counts to retailers and manufacturers.

The entities associated with computer systems 2-7 are each associated in FIG. 1 with a computer system and Internet connection for convenience. Not all of that functionality is required to implement certain embodiments of the invention.

The marketing services provided by the marketing company include marketing of invitations. The marketing company preferably offers invitation marketing programs to publishers of periodicals and retailers. An invitation marketing program consists of offering invitations to consumers meeting invitation offer criteria based upon POS data associated with the consumers. The marketing company may use central computer system 2 to analyze POS data for consumers stored in central computer system 2's database 12 to determine consumer records meeting invitation offer criteria. Alternatively, the marketing company may provide to the legal entity owning retail computer system 3 software to perform invitation offer criteria analysis on POS data stored in retail computer system 3's database 13. The marketing company uses central computer system 2 and data in its database 12, via data mining techniques applied to historical POS data and historical invitation marketing programs data to determine statistical likelihoods of a consumer associated with certain data to respond to a specified invitation by accepting the invitation.

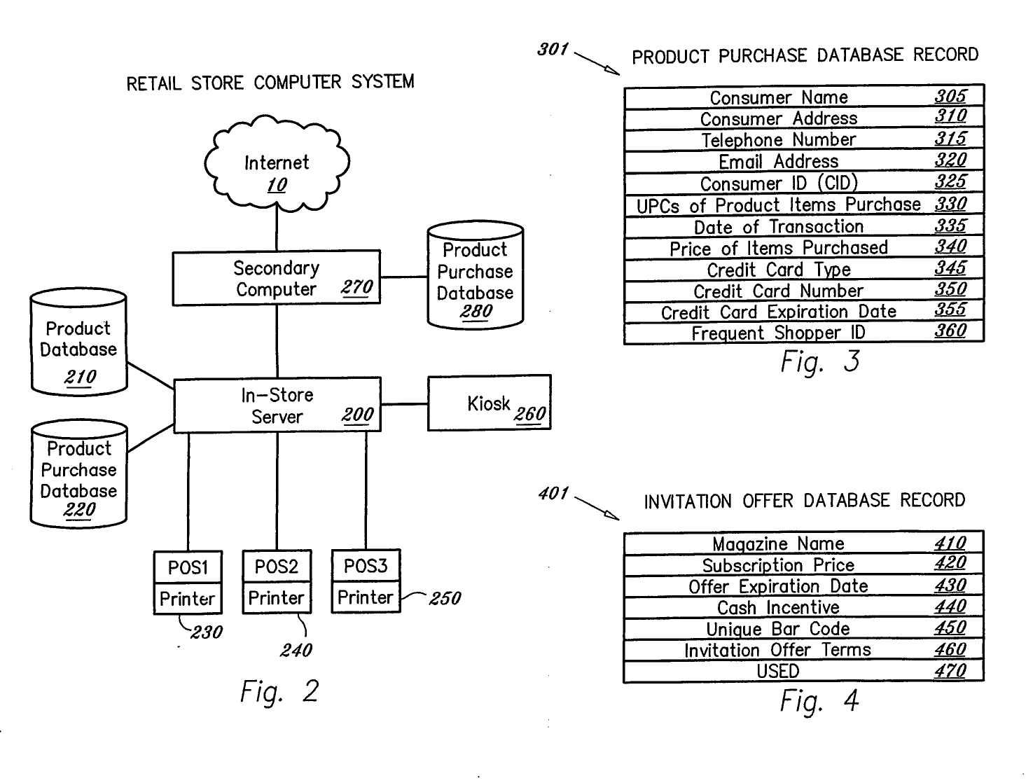

FIG. 2 shows details of retail store computer system 3. Retail store computer system 3 manages data relating preferably one retail store. Retail store computer system 3 includes in-store server 200, product database 210, first POS terminal 230, and optionally second POS terminal, third POS terminal 250, etc. Each POS terminal preferably includes a printer.

Retail store computer system 3 may also include kiosk 260, secondary computer 270, and one or both of product purchase database 280 and product purchase database 220.

In one embodiment, kiosk 260 is where consumers receive invitations or accept invitations, or both. Kiosk 260 preferably includes means to read a consumer identification so that in-store server 200 or central computer system 2 can respond accordingly.

In various embodiments, a database, such as 210, 220, or 280 also stores data indicating consumers to whom to offer invitations, or database 12 stores data indicating consumers to whom to offer invitations. In other embodiments, retail computer system 2 or central computer system 2 determines whether and which invitations to offer to a consumer while a consumer is determined to be at a POS terminal or a Kiosk. Consumers are determined to be at a terminal or a Kiosk when they are identified by a device reading a CID or by the consumer entering identification information into an input device, such as a keyboard or mouse. Determining whether and which invitations to offer to a consumer while a consumer is determined to be at a POS terminal or a Kiosk and then offering the consumer the determined invitations is defined herein as “real time” invitation offering.

FIG. 3 shows a representation of product purchase record 301. Product purchase record 301 represents data for a transaction. It shows fields names for field of record 301. Each field stores corresponding data. Each product purchase record in a product purchase database generally contains the fields identified in product purchase database record 301, although in different data structures. Preferably, a product purchase database is contained in central computer system 2's database 12 and retail store computer system 3's database 13.

Product purchase record 301 preferably includes consumer name field 305, consumer address field 310, telephone number field 315, email address field 320, CID field 325, UPCs field 330, date of transaction field 335, prices of items purchased field 340, credit card type field 345, credit card number field 350, credit card expiration date field 355, frequent shopper identification code field 360.

Consumer name field 305 stores the name of a consumer provided by the consumer or associated with the consumer's CD. Frequent shopper identification code field 360 stores the code on a frequent shopper card associated with a consumer. Consumer address field 310 stores the address of the consumer, including street address, city, state, and zip code. Telephone number field 315 stores the consumer's telephone number, including home phone, work phone, and cell phone numbers. Email address field 320 stores the email address of the consumer. CID field 325 stores a CID linked to a consumer. UPCs field 330 stores UPCs of products purchased in association with either the CID or frequent shopper card 1D. Date of transaction field 335 stores the date of the transaction data for which is stored in purchase record 301. Price of items purchased field 340 stores the prices for the individual items identified by the UPCs in UPCs field 330. Credit card type 345 stores the type of credit card, if products were purchased by credit card, such as Visa or Mastercard. Credit card number field 350 stores the credit card number used during the transaction relating to product purchase record 301. Credit card expiration date field 355 stores the date in which the credit card identified in credit card number field 350 expires. Frequent shopper ID field 360 stores a frequent shopper card identification associated with the CID. Product purchase record 301 is exemplary only since may different formats may be used to store POS data associated with a consumer. For example, data may be reorganized so that consumer name and address information is not duplicated in each consumer transaction record, and data may be reorganized and stored by product instead of transaction.

FIG. 4 shows a representation of invitation offer record 401. Invitation offer record 401 represents data for an invitation that is available for an invitation offer. It shows fields names for fields of record 401. Each field stores corresponding data. Each invitation offer record in an invitation offers database generally contains data for the field names shown in invitation offer record 401. Preferably, an invitation offers database is contained in central computer system 2's database 12 and retail store computer system 3's database 13.

Invitation offer record 401 preferably includes magazine name field 410, subscription price field 420, offer expiration date field 430, cash incentive field 440, and unique bar code field 450. Optionally, invitation offer record 401 includes additional fields 460 identifying additional invitation offer terms. Optionally, invitation offer record 401 includes USED field 470, which may store a boolean value indicating whether the corresponding unique bar code 450 has been used in an offer of an invitation.

If the invitation is an offer to purchase a product or service other than a periodical subscription, the magazine name field 401 contains the description of the product or service offered, and the optional fields for recording subscription related information are not included. While the disclosure below discusses field names in terms of magazines, aspects of the invention may be applicable to any periodical subscription, product, or service.

Magazine name 410 stores the name of the magazine or other periodical publication, product, or service for which an invitation is offered. Subscription price 420 stores the price of the subscription associated with the invitation. Offer expiration data 430 stores the date when the invitation will expire. Cash incentive 440 stores the incentive for the retail store that a consumer will receive if they purchase a magazine subscription from the retail store. Unique bar code 450 stores data defining a code, including terms identifying the offer such as magazine name, price, and offer expiration date.

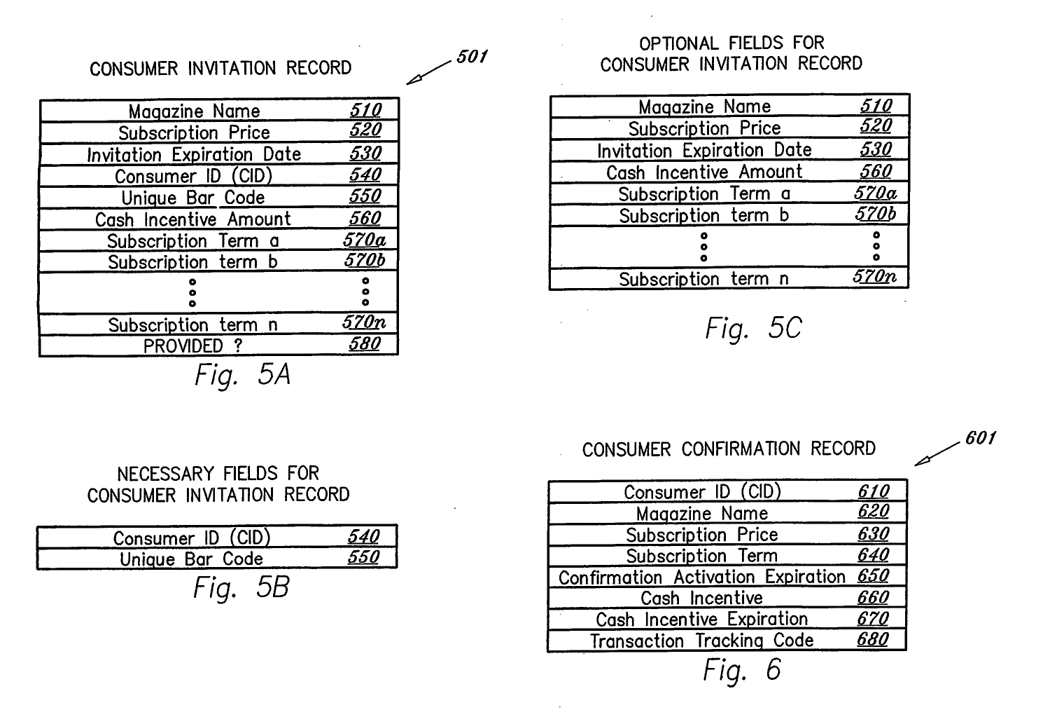

FIG. 5A shows a representation of consumer invitation record 501. Consumer invitation record 501 represents data associated with an invitation offer. It shows field names for fields of record 501. Each field stores corresponding data. Each consumer invitation record in a consumer invitations database generally preferably contains data for at least the field names shown in FIG. 5B, which are CID field 540 and unique bar code field 550. Each consumer invitation record may also contain the additional fields and data shown in records in FIGS. 5A and 5C. Preferably, a consumer invitations database is contained in central computer system 2's database 12. A consumer invitations database may also be stored in publisher computer system 5's database 15, activation center computer system 6's database 16, and retailer computer system13's database 13.

Consumer invitation record 501 includes magazine name field 510, subscription price field 520, invitation expiration data field 530, CID field 540, unique bar code field 550, cash incentive amount field 560, and subscription term fields 570a . . . 570n. The database may contain multiple subscription terms such as 580. Preferably, consumer invitation record 501 also includes a PROVIDED field 580, which stores a boolean value indicating whether the corresponding invitation has actually been provided to the consumer.

Magazine name field 510 stores the name of the periodical publication that was offered to the consumer. Subscription price field 520 stores the invitation's price of the subscription for the magazine. Invitation expiration date field 530 stores the date when the invitation will expire. CID field 540 stores a CID linked to a consumer. Unique bar code field 550 stores data defining a code, associated with the invitation. This code is associated in a database with terms identifying the corresponding subscription offer, such as magazine name, price, and offer expiration date. Cash incentive amount field 560 stores the amount of a cash incentive that a consumer will receive at a retail store if they accept the invitation at the retail store. Subscription term a field 570a stores a description of a contractual term of the subscription. Subscription term 570b, . . . 570n store additional contractual terms of the subscription.

FIG. 5B shows necessary fields 540 and 550 for consumer invitation records. The necessary fields are the CID field 540 and the unique bar code field 550.

FIG. 5C shows optional fields for consumer invitation records. The optional fields are the magazine name field 510, subscription price field 520, invitation expiration data field 530, cash incentive amount field 560, subscription term fields 570a-570n.

FIG. 6 shows a representation of consumer confirmation record 601. Consumer confirmation record 601 represent data indicating a consumer has accepted an invitation. It shows field names for fields of consumer confirmation record 601. Each field stores corresponding data. Each consumer confirmation record in a consumer confirmations database generally contains data for the fields whose names are shown in consumer confirmation record 601. Preferably, a consumer confirmation records database is contained in activation center computer system 6's database 16 and in central computer system 2's database 12, and in mailing facility computer system 4's database 14.

Consumer confirmation record 601 preferably includes CID field 610, magazine name field 620, subscription price field 630, subscription term field 640, confirmation activation expiration field 650, cash incentive field 660, cash incentive expiration date field 670, and unique transaction tracking code field 680.

CID field 610 stores a consumer's CID. Magazine name field 620 stores the name of the periodical publication identified in the invitation provided to the consumer. Subscription price field 630 stores the price of the subscription identified in the invitation. Confirmation activation expiration date field 650 stores the time period during which the consumer can accept the invitation or the final date upon which the consumer can accept the invitation. Cash incentive field 660 stores the value of a cash incentive that the retail store will provide to the consumer if the consumer accepts the invitation from the retail store. Cash incentive expiration field 670 stores the date prior to which the consumer must obtain the cash incentive. Unique transaction tracking code field 680 stores the data for a unique code that is printed on the confirmation, and with which is preferably associated magazine name, subscription price, and consumer name.

In overview of the method of operation of the invention, retail store computer system 3 receives POS data when a customer purchases products, which data is associated with the customer's CID. The POS data is stored in one or more product purchase databases, such as in databases 12, 13, 210, and 220. Additional data associated with the CID may be stored in those databases, including the consumer's demographic data, the consumer's profile data, and the consumer's block data.

A computer system (such as retail store computer system 3 or central computer system 2) having access to the POS data and optionally other data receives data relating to a marketing program involving a periodical publication or other non stocked product or service, such as the name of the publication or non stocked item, terms of subscriptions, and number of invitations that can be generated. The computer system receives or determines invitation offer criteria, access to the POS data, and identifies consumer CIDs for consumers whose associated data (including any one or more of the consumer's POS data, the consumer's demographic data, the consumer's profile data, and the consumer's block data) meets the invitation offer criteria. The computer system transmits CIDs selected because their associated data met the invitation offer criteria to a facility for delivery to the corresponding consumer, such as a retail store for POS terminal or Kiosk delivery of an invitation, or to a mailing center for mailing to the consumer.

The consumer can accept the invitation at a POS terminal or a Kiosk in a retail store, in which case the acceptance information is recorded at the POS and the customer is provided with a confirmation and optionally activation instructions. The activation instructions may instruct the consumer to telephone a particular number to complete the subscription process, for example, by providing a code associated with the confirmation, or providing or confirming a mailing address or other information.

Once a subscription is activated, mailing instructions are transmitted to the mailing facility, which then effects either mailing of the product purchased by the consumer or periodic mailings of issues of the periodical publication to which the consumer has subscribed. If a service was purchased, the activation information is transmitted to the applicable service provider (such as a satellite TV, cable TV, or Internet) service provider.

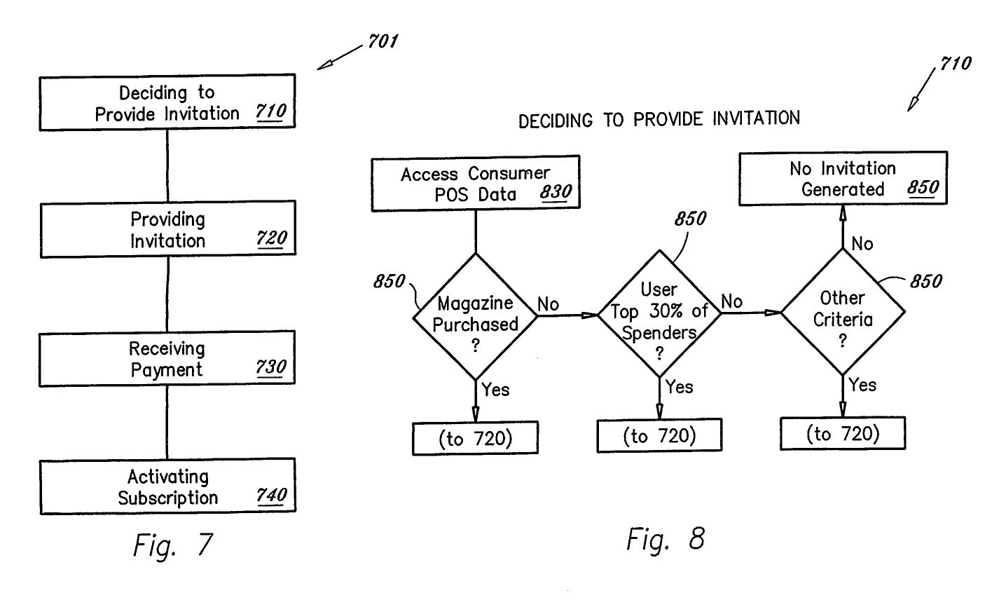

The method of the invention is now described with reference to FIGS. 7-10.

FIG. 7 is high level flowchart 701. High level flowchart 701 includes the steps of deciding to provide invitation 710, providing invitation 720, receiving payment 730, and activating subscription 740.

In step 710, central computer system 2 decides whether to offer an invitation.

In step 720, central computer system 2 provides the customer an invitation.

In step 730, the customer purchases the magazine subscription at the point of sale by ringing the invitation to the store and paying the price indicated on the invitation. In response, the central computer system 2 will provide the consumer a confirmation.

In step 740, the customer activates the subscription, preferably by calling a telephone number shown on the confirmation. In response to receipt of the telephone call, activation center 6 stores the activation information in activation center 6's database 16.

In step 710, central computer system 2 decides whether to offer an invitation by applying invitation offer criteria that depends upon values of POS data and optionally other data associated with the consumer, such as the consumer's prior product purchases, concurrent product purchases, concurrent transaction data, demographic data, preference data, profile data, and block data.

Preference data is data indicating the consumer's preferences. Profile data is data derived from POS data correlated to statistically derived preference data. Block data is statistical data derived for a relatively small geographic region, such as a street, a block, a sub-division, or a section of a town.

Invitation offer criteria may include any one or more of the following: whether the consumer previously bought a magazine, a newspaper, is profiled or classified as within a certain group, such as a group of consumers spending more than a specified value per time period, is classified as within a specified top fraction of spenders, such the top 50%, 30%, or 10% of spenders, or a group profiled to have a preference for a certain sport or hobby, such as hunting, cooking, sports, politics, etc., whether the consumer's block data meets certain criteria, such as income level, number of cars, number of family members, number of children, whether the consumer's purchases indicate that the consumer has a demographic associated with the content of a certain periodical publication, whether the consumer has purchased a periodical with content similar the content of a periodical publication for which an invitation may be offered (a competing periodical), whether the consumer frequently purchases issues of periodical publications, whether the consumer infrequently purchases issues of periodical publications, and whether the consumer purchases products associated with reading periodical publications, such as coffee or orange juice.

In one embodiment, the central computer system selects consumers based on data indicating which magazines they purchased. For example, invitations for a subscription to “People” magazine will be given to a consumer who purchases an issue of People. In another example, a consumer that purchases Time may be given an invitation for a subscription to Newsweek, since Time and Newsweek have similar content and therefore compete with one another for sales to consumers. That is, the system may, in response to noticing that the consumer has purchases an issue of a periodical publication, offer the consumer a subscription to a competing periodical publication during the consumer's same or a subsequent shopping visit.

Central computer system 2 can perform step 710 at any time. Central computer system 2 can perform step 710 in response to receipt of data from retail store computer system 3, at predetermined times, such as midnight every night, or in response to a command received via an input device from an operator. Central computer system 2 can store in database 12 the decision whether to offer an invitation to a customer.

Central computer system 2 can also decide whether to provide the customer an invitation in response to receipt of data at POS terminal 230 or Kiosk 260 in retail store computer system 3 indicating that the customer is in the process of making a transaction at that terminal. Central computer system 2 can transmit the decision to retail store computer system 3 in which case retail store computer system 3 can instruct POS terminal 230 or Kiosk 260 to provide an invitation to the consumer.

Central computer system 2 can transmit the decision whether to offer an invitation to the customer to retail store computer system 3 at any time, such as immediately after central computer system 2 makes its determination, at predetermined times, such as midnight every night, upon a command received via an input device from an operator, and upon a request to transmit received from retail store computer system 3.

Alternatively, retail store computer system 3 can decide whether to offer an invitation to a customer. Retail store computer system can decide to offer the invitation based upon applying invitation offer criteria to data stored in retail store computer system's database 13 (alternatively including databases 220 and 270), by applying invitation offer criteria to data as it is received from POS terminal 230 or Kiosk 260, or predetermined times, in response to a command received from an operator, or in response to a command received from central computer system 2.

In step 720, if central computer system receives data from retail store computer system 3 (including data received directly from POS terminal 230 or Kiosk 260), central computer system 2 can transmit instructions directly to POS terminal 230, Kiosk 260, secondary computer 270, or in-store server 200 to provide an invitation to the consumer during the transaction.

In step 720, retail store computer system 3 may instruct POS terminal 230 or Kiosk 260 to generate or print an invitation in response to receipt of data indicating that the customer is at POS terminal 230 or Kiosk 260, such as receipt of the customer's CID from POS terminal 230 or Kiosk 260.

POS terminal 230 or Kiosk 260 can print the invitation when the consumer is present. Alternatively, they can transmit the invitation to a handheld computer or similar wireless device having wireless transmission and the ability to store electronic documents that is associated with the consumer, also called a personal digital assistant (PDA).

Either central computer system 2 or retail store computer system 3 may instruct mailing facility 4 to generate and postal mail or email an invitation to a consumer's postal address or email address.

In step 730, the consumer may accept the invitation and pay for the subscription at POS terminal 230 or Kiosk 260. The consumer may do this in connection with another transaction at POS terminal 230, such as purchase of grocery products.

The consumer can provide a printed invitation to POS terminal 230 or Kiosk 260 in which case preferably a scanner associated with POS terminal 230 or Kiosk 260 reads a bar code on the invitation uniquely identifying the invitation and the consumer. Alternatively, the consumer may instruct the consumer's PDA to transmit an acceptance to of the invitation to POS terminal 230 or Kiosk 260.

In step 730, POS terminal 230 records POS data and acceptance by the consumer of the invitation and transmits that data to in-store server 200. In-store server 200 preferably transmits the POS data to central computer system 2, and it may store the data in database 13.

Preferably, as part of step 730, the POS terminal 230 or Kiosk 260 prints or transmits to the consumer's PDA a confirmation. Preferably, associated with the confirmation is a unique code. If the confirmation is a printed document, the code is preferably realized as a scanner readable bar code. The confirmation may include additional information, either in human or machine readable form, including the name and address of the consumer, and the consumer's CID). The confirmation includes human readable instructions for activating the subscription.

In step 740, the consumer follows the instructions in the confirmation to activate the subscription.

In step 740, if the confirmation is a printed document, the consumer telephones a number contacting a person at the activation center or the activation computer system 6 to activate the paid for subscription. The activation system 6 saves the consumer name, address, and type of magazine purchased in the activation center computer system 6's database 16. The activation center computer system 6 preferably sends this data to the publisher computer system 5, and possibly to the mailing facility computer system 4. Publisher computer system 5 saves this data in a database and preferably sends an order to mailing facility computer system 4 to fulfill the subscription. Alternatively, central computer system 2 can perform the activation functions of activation computer system 6 and publisher computer system 5.

Alternatively, combining steps 730 and 740, the consumer may fill out a form authorizing credit (for example to charge the consumer's credit card) or attach a check to the invitation to effect payment for a subscription, fill out any additional information requested by writing on the invitation (such as name, postal mailing address, email address, and CID), and mail that to the activation center associated with activation center computer system 6, thereby indicating acceptance of the invitation and paying for the invitation. Personnel at the activation center enter data provided by the consumer's acceptance into activation center computer system 6, which stores that data in its database 16. If there is an incentive for the retail store associated with retail store computer system 3 included in the accepted invitation, activation center computer system 6 can transmit the identify of the consumer (eg., the consumer's CID) and the acceptance of the invitation or the specified incentive information to retail store computer system 3. Retail store computer system 3 can provide the incentive to the consumer at the POS contingent upon the consumer fulfilling any outstanding preconditions associated with the incentive offer, such as purchasing a larger dollar value than the amount of a cash incentive.

Invitations accepted at the POS are forwarded to coupon clearing house associated with computer system 7, where the number of accepted invitations may be counted and reconciled with the accounts of the retailer and the publisher regarding the number of invitations accepted.

In addition, central computer system 2, retail computer system 3, publisher computer system 4, or activation center computer system 6 may store data indicating acceptances, and generate accounting information for distributing credits for accepted invitations (including charges for subscription sales and costs for incentives) according to a predefined business arrangement between any number of the owners of central computer system 2, retail store computer system 3, mailing facility computer system 4, publisher computer system 5, activation center computer system 6, and coupon clearinghouse computer system 7. Based the owners of systems 2-7 transfer funds amongst their respective financial accounts.

FIG. 8 is a middle level flowchart showing exemplary steps for step 710, deciding to provide an invitation to a consumer. FIG. 8 includes steps 810 for accessing consumer POS data, 820 for determining whether a magazine was purchased by the consumer, 830 for determining whether the user was in the top 30 percent of spenders, 840 determining whether the consumer's POS data meets other criteria, and step 850 deciding to offer no invitation. This function is preferably performed by central computer system 2 or secondary computer system 270.

A positive decision in steps 820, 830, or 840 results in storing a decision to offer an invitation to the consumer, and storing of that decision in a database. The process of storing the decision involves either deleting one invitation offer record (see FIG. 4) for the corresponding invitation from an invitation offer database or entering data in an invitation offer record indicating that the corresponding unique bar code 450 has been used in an invitation offered to a consumer, such as by changing a boolean value in the USED field 470. The process of storing the decision also involves generating a new consumer invitation record in the consumer invitation record database. Upon actually providing an invitation to a consumer, preferably invitation offer record 401 is updated to indicate in the USED field 470 that the invitation has actually been provided to the consumer.

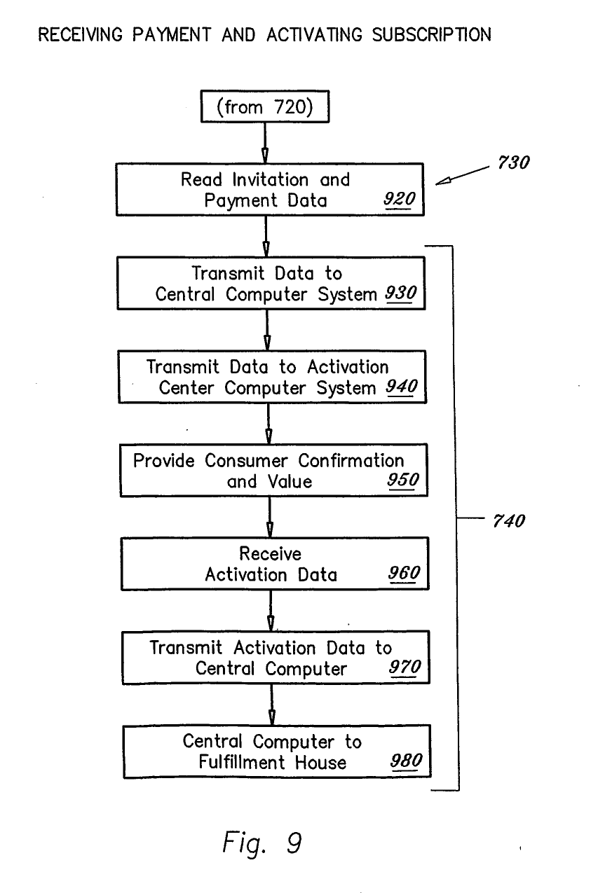

FIG. 9 is a middle level flowchart showing steps for receiving payment 730 and activating subscription 740. FIG. 9 includes step 920 for reading invitation data and payment data at POS terminal 230, step 930 for transmitting data from POS terminal 230 to central computer system 2, step 940 for transmitting data from central computer system 2 to activation center computer system 6, step 950 for providing a consumer confirmation and incentive value, step 960 for activating a subscription in activation center computer system 960, step 970 for transmitting activation data to central computer system 2, and step 980 for transmitting activation data to mailing facility computer system 4.

In step 920, POS terminal 230 reads the unique bar code on the invitation and receives payment data.

In step 930, the POS transfers data via in-store server 200 to central computer system 2 acceptance data. In response, central computer system 2 stores the acceptance data in consumer confirmation record 601.

In step 940, preferably central computer system 2 transfers the consumer confirmation record 601 to activation center computer system 6. In response, activation center computer system 6 stores this information in its database 16.

In step 950, the consumer receives preferably from POS terminal 230 a printed confirmation and any cash incentive or discount on purchases included in the invitation. In the preferred embodiment the incentive offer included in the invitation is a cash incentive limited to redemption in the retail store.

In step 960, the consumer contacts the activation center, preferably by telephoning a telephone number appearing on a printed confirmation. The telephone number is preferably a telephone number for the activation center computer system 6. The activation center computer system 6 records the activation of the subscription.

In step 970, the activation center computer system 6 transmits the activation information to central computer system 2.

In step 980, central computer system 2 transmits the activation data to mailing facility computer system 4. This information is then used to by the mailing facility to deliver to the consumer issues of the periodical publication defined by the subscription.

In particular, the preferred embodiment of the novel system and method for offering incentives and subscriptions to consumers are based on POS purchase data, and use POS technology to communicate with the consumers. Invitations are delivered with a unique bar code that identifies the periodical publication's name, term and price for the offered subscription. Once the consumer purchases the magazine subscription, the system delivers a confirmation message that includes a unique tracking code, confirmation of order (magazine name, term, price) and cash value incentive. It will be appreciated that, although a limited number of embodiments of the invention have been described in detail for purposes of illustration, various modifications may be made without departing from the spirit and scope of the invention. Accordingly, the invention should not be limited except as by the appended claims.

1. A computer network implemented method, comprising:
receiving a CID;
storing said CID in memory in association with an invitation code when data associated with said CID meets invitation offer criteria associated with said invitation code;
storing in association with said invitation code contract terms comprising terms for a contract for a subscription to a periodical publication;
transmitting to an offer terminal data defining said CID and said invitation code in order to provide an invitation to a consumer;
receiving from an acceptance terminal said invitation code in association with said CID subsequent to said transmitting indicating acceptance of said invitation by said consumer; and
storing said CID in association with a transaction tracking code.

2. The method of claim 1 further comprising determining whether consumer data associated with said CID meets said invitation offer criteria.

3. The method of claim 2 wherein said invitation offer criteria comprises criteria for POS data.

4. The method of claim 2 wherein said invitation offer criteria comprises criteria for block data.

5. The method of claim 2 wherein said invitation offer criteria comprises criteria for preference data.

6. The method of claim 2 wherein said invitation offer criteria comprises criteria for profile data.

7. The method of claim 2 wherein said invitation offer criteria comprises criteria for demographic data.

8. The method of claim 2 wherein said invitation offer criteria comprises criteria for magazine purchases.

9. The method of claim 1 wherein said contract terms comprise a name of said periodical publication.

10. The method of claim 1 wherein said contract terms comprise a price for said subscription.

11. The method of claim 1 wherein said contract terms comprise an expiration date for said invitation.

12. The method of claim 1 wherein said contract terms include terms of an incentive offer.

13. The method of claim 12 wherein said terms of said incentive offer include acceptance of said invitation.

14. The method of claim 12 wherein said terms of said incentive offer include a cash discount.

15. The method of claim 1 wherein said transmitting comprises transmitting when said CID is involved in a transaction at said offer terminal.

16. The method of claim 1 further comprising updating an invitation offer record in an invitation offer database to indicate code associated with said record has been used in an invitation offered to a customer.

17. The method of claim 16 wherein said invitation offer record also stores at least one of the following items: a name of a periodical publication, a subscription price, an offer expiration date, and an incentive offer.

18. The method of claim 16 wherein said invitation offer record also stores at least two of the following items: a name of a periodical publication, a subscription price, an offer expiration date, and an incentive offer.

19. The method of claim 1 further comprising generating or updating a consumer invitation record in a consumer invitation database to store a CID and a unique code.

20. The method of claim 19 wherein said consumer invitation record also stores at least one of the following items: a name of a periodical publication, a subscription price, an invitation expiration date, incentive offer, subscription term.

21. The method of claim 19 wherein said consumer invitation record also stores at least two of the following items: a name of a periodical publication, a subscription price, an invitation expiration date, incentive offer, subscription term.

22. The method of claim 19 wherein said consumer invitation record also stores data indicating whether said invitation has been provided to said consumer.

23. The method of claim 1 further comprises receiving payment for said subscription when receiving from said acceptance terminal said invitation code.

24. The method of claim 23 further comprising receiving payment for product purchases concurrently with receiving said payment for said subscription.

25. The method of claim 1 further comprising generating a consumer confirmation record in a consumer confirmation database after receiving from said acceptance terminal said invitation code.

26. The method of claim 25 wherein said consumer confirmation record includes a CID and a transaction tracking code.

27. The method of claim 26 wherein said consumer confirmation record also includes at least one of the following items: a name of a periodical publication, a subscription price, a subscription term, a confirmation activation expiration date, an incentive offer, and an incentive offer expiration date.

28. The method of claim 26 wherein said consumer confirmation record also includes at least two of the following items: a name of a periodical publication, a subscription price, a subscription term, a confirmation activation expiration date, an incentive offer, and an incentive offer expiration date.

29. The method of claim 1 wherein at least one criteria of said invitation offer criteria is whether a magazine is purchased.

30. The method of claim 1 wherein at least one criteria of said invitation offer criteria is whether said consumer user is in a specified top fraction of spenders.

31. The method of claim 1 wherein said invitation is provided to said consumer via direct mail.

32. The method of claim 1 wherein said invitation is provided to said consumer via printing at an in-store printer.

33. The method of claim 1 further comprising activating said subscription.

34. The method of claim 33 wherein said activating comprises receiving at an activation center a telephone call from said consumer.

35. The method of claim 33 wherein said activating comprises receiving a mailing from said consumer.

36. The method of claim 33 wherein said activating comprises receiving activation data transmitted by said consumer over the Internet.

37. The method of claim 1 further comprising printing said invitation and including a printed unique bar code.

38. The method of claim 37 wherein magazine name, magazine subscription price, and offer expiration date are encrypted in said unique bar code.

39. The method of claim 1 wherein magazine name, magazine subscription price and offer expiration date are encrypted in said transaction tracking code.

40. The method of claim 1 further comprising providing at least two of the following items: a retail store computer system, a central computer system; an activation center computer system, a publisher computer system, a mailing facility computer system, and a coupon clearing house computer system.

41. The method of claim 1 further comprising providing at least three of the following items: a retail store computer system, a central computer system; an activation center computer system, a publisher computer system, a mailing facility computer system, and a coupon clearing house computer system.

42. The method of claim 1 further comprising storing POS data in association with CIDS in a consumer data database.

43. The method of claim 42 wherein said consumer data database also stores in association with CIDs at least one of the following items: profile data, preference data, demographic data, and block data.

44. A computer network system, comprising:
a central processor and associated memory;
a terminal for receiving a CID;
a consumer data database storing data in association with CIDs;
memory structure for storing said CID in association with an invitation code when data in said consumer data database associated with said CID meets invitation offer criteria associated with said invitation code;
memory structure for storing in association with said invitation code contract terms comprising terms for a contract for a subscription to a periodical publication;
an offer terminal; a network transmitter for transmitting to said offer terminal data defining said CID and said invitation code in order to provide an invitation to a consumer;
an acceptance terminal; a network receiver for receiving from said acceptance terminal said invitation code in association with said CID indicating acceptance of said invitation by said consumer; and
memory structure for storing said CID in association with a transaction tracking code.

45-86. (canceled)

87. A computer network program product, comprising code stored on a computer readable medium for performing the following steps when loaded on networked computers:
receiving a CID;
storing said CID in memory in association with an invitation code when data associated with said CID meets invitation offer criteria associated with said invitation code;
storing in association with said invitation code contract terms comprising terms for a contract for a subscription to a periodical publication;
transmitting to an offer terminal data defining said CID and said invitation code in order to provide an invitation to a consumer;
receiving from an acceptance terminal said invitation code in association with said CID subsequent to said transmitting indicating acceptance of said invitation by said consumer; and
storing said CID in association with a transaction tracking code.

88. A computer implemented method, comprising:
a consumer providing to a POS terminal their CID;
storing said CID in memory in association with an invitation code when data associated with said CID meets invitation offer criteria associated with said invitation code;
storing in association with said invitation code contract terms comprising terms for a contract for a subscription to a periodical publication;
said consumer receiving at a POS terminal an invitation including data defining said CID and said invitation code;
said consumer providing to a POS terminal said invitation code in association with said CID subsequent to receiving said invitation, thereby indicating acceptance of said invitation by said consumer; and
storing said CID in association with a transaction tracking code.

89. A computer network implemented method, comprising:
receiving a CID associated with a consumer;
storing said CID in memory in association with an invitation code when data associated with said CID meets invitation offer criteria associated with said invitation code;
storing in association with said invitation code contract terms comprising terms for a contract for at least one of a product and a service;
transmitting to an offer terminal data defining said CID and said invitation code in order to provide an invitation including an offer for said at least one of a product and a service to said consumer;
receiving from an acceptance terminal said invitation code in association with said CID subsequent to said transmitting indicating acceptance of said invitation by said consumer; and
storing said CID in association with a transaction tracking code.

90. (canceled)

91. A computer network system, comprising:
a central processor and associated memory;
a terminal for receiving a CID associated with a consumer;
a consumer data database storing data in association with CIDs; memory structure for storing said CID in association with an invitation code when data in said consumer data database associated with said CID meets invitation offer criteria associated with said invitation code;
memory structure for storing in association with said invitation code contract terms comprising terms for a contract for at least one of a product and a service;
an offer terminal;
a network transmitter for transmitting to said offer terminal data defining said CID and said invitation code in order to provide an invitation to purchase said at least one of said product and said service to said consumer;
an acceptance terminal;
a network receiver for receiving from said acceptance terminal said invitation code in association with said CID indicating acceptance of said invitation by said consumer; and
memory structure for storing said CID in association with a transaction tracking code.
